(19) United States
(12) Patent Application Publication
(10) Pub. No.: US 2015/0159869 A1
(43) Pub. Date: Jun. 11, 2015

(54) PORTABLE, SOLAR RECHARGEABLE, BATTERY POWERED, FLAMELESS IGNITING DEVICE

(71) Applicants: Kurt W. Stevenson, New Port Richey, FL (US); Giuseppe Lombardo, New Port Richey, FL (US)

(72) Inventors: Kurt W. Stevenson, New Port Richey, FL (US); Giuseppe Lombardo, New Port Richey, FL (US)

(21) Appl. No.: 14/529,343

(22) Filed: Oct. 31, 2014

Related U.S. Application Data
(60) Provisional application No. 61/898,071, filed on Oct. 31, 2013.

(51) Int. Cl. F23Q 7/16; H02J 7/00; F23Q 7/24

(52) U.S. Cl. CPC F23Q 7/16; F23Q 7/24; H02J 7/0047; H02J 2007/0049; H02J 2007/0037; H02J 2007/0062

(57) ABSTRACT

The present invention relates to a solar rechargeable, battery powered, electric igniting device that includes: a cylindrical housing having a first and second end, a length, an top flat surface, and at least one heating element disposed at the first end; a photovoltaic array disposed over the top surface, where the array is capable of receiving light; at least one rechargeable battery; a first indicator, where the first indicator indicates when the battery is receiving a charge or is fully charged; a second indicator, where the second indicator indicates when the at least one heating element is being energized; a slide mechanism to activate the device; and a charge regulating circuit to regulate the charging of a battery and said a charge regulating circuit includes a means to connect to an external power source.

### CROSS REFERENCE TO OTHER APPLICATIONS

This application claims priority to U.S. Provisional Application Ser. No. 61/898,071 filed on Oct. 31, 2013.

### FIELD OF THE INVENTION

The present invention relates to a solar rechargeable device for starting or igniting fire, where the device is electrically powered and rechargeable via an onboard photovoltaic solar panel, a rechargeable battery component, and a large heating coil element. No gas or carbon is required. The device produces no flame and is electrically operated and environmentally friendly.

The primary purpose of the invention is to provide a device for starting or igniting fire, such as camp fires for cooking and boiling water in an emergency response, disaster recovery situation, or disaster preparedness where butane, electric, or other ignition sources are not present.

### BACKGROUND OF THE INVENTION

Mini, battery operated, rechargeable flameless cigarette and cigar lighters have long been known and widely used. Most of these lighters receive power from AA or AAA batteries, or may be recharged via USB or electronic plugin, and have limited use such as lighting a cigarette or cigar. As such the prior art lighters have limited means to power and charge the functions related to operation of the respective lighter.

Solar power typically relates to the use UV rays from the sun directed toward a photovoltaic array where the photovoltaics convert the UV light into electrical current. Solar arrays are used to power a variety of devices and have been applied to power homes. With respect to lighters however, the aforementioned devices do not include the use of solar arrays to re-charge and ignite via onboard solar power.

To address this deficiency, the present invention provides a flameless, battery powered, solar rechargeable fire starting device with a heating element, which is largely exposed to allow for easy contact and ignition of combustible material such as paper, dried leaves, cloth or magnesium flakes.

### SUMMARY OF THE INVENTION

This present invention relates to a flameless battery powered electric rechargeable fire starting device with a resistance heating element positioned at one end such that it protrudes approximately ½″ past the tip of the device housing so that the heating element contacts a combustible material and ignites. Simultaneously depressing a safety button and sliding a mechanism from the home position to a second position activates the heating element. The movement of the mechanism to the second position contacts a micro switch, which in turn closes the circuit and activates the heating element. The device is powered by a Lithium Iron Phosphate battery. The battery is rechargeable via a mini onboard photovoltaic panel recessed into an inset surface on the housing. The battery may also be charged via mini USB connector, which is disposed on the end opposite the heating element and connected to a charging regulating circuit thereby preventing over charging of the device via USB connection. Other features of the invention and the manner in which the foregoing and other objects of the invention are achieved will be most readily understood by referring to the following detailed description and drawings.

### BRIEF DESCRIPTION OF DRAWINGS

FIG. 1 depicts a side section view illustration in accordance with the present invention showing various components thereof;

FIG. 1A depicts an isometric view illustration in accordance with the present invention;

FIG. 2 depicts a top view drawing in accordance with the present invention;

FIG. 3 depicts a side view illustration in accordance with the present invention;

FIG. 4 depicts a front and back view in accordance with the present invention;

FIG. 5 depicts an isometric view of the circuit board in accordance with the present invention;

FIG. 5A depicts a front and back view of the circuit board in accordance with the present invention;

FIG. 5B depicts a side view of the circuit board in accordance with the present invention;

FIG. 6 depicts a 3D rendering of a device in accordance with the present invention.

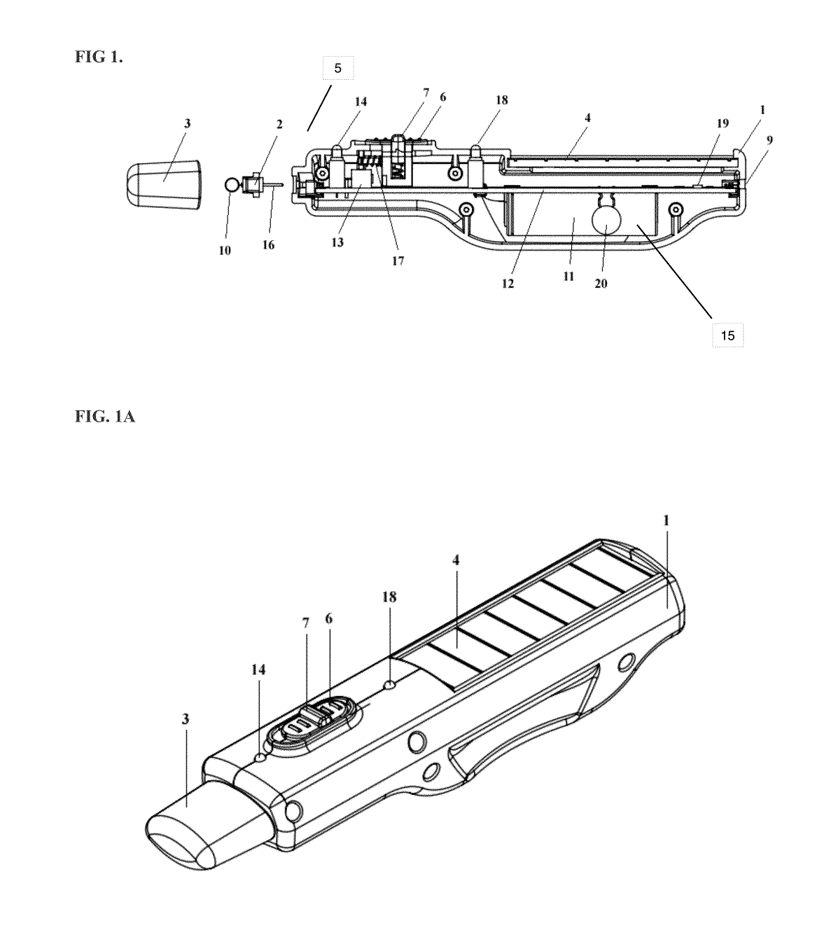

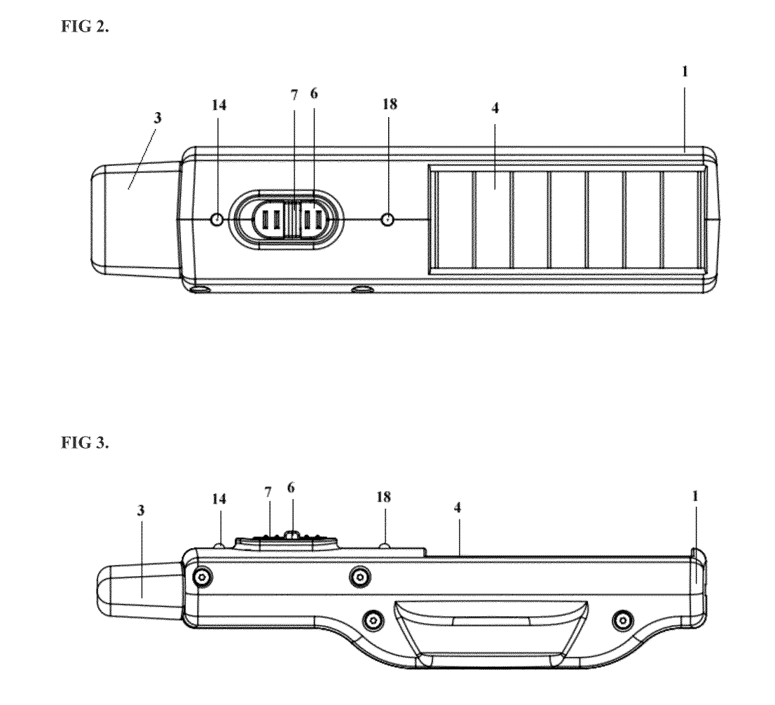

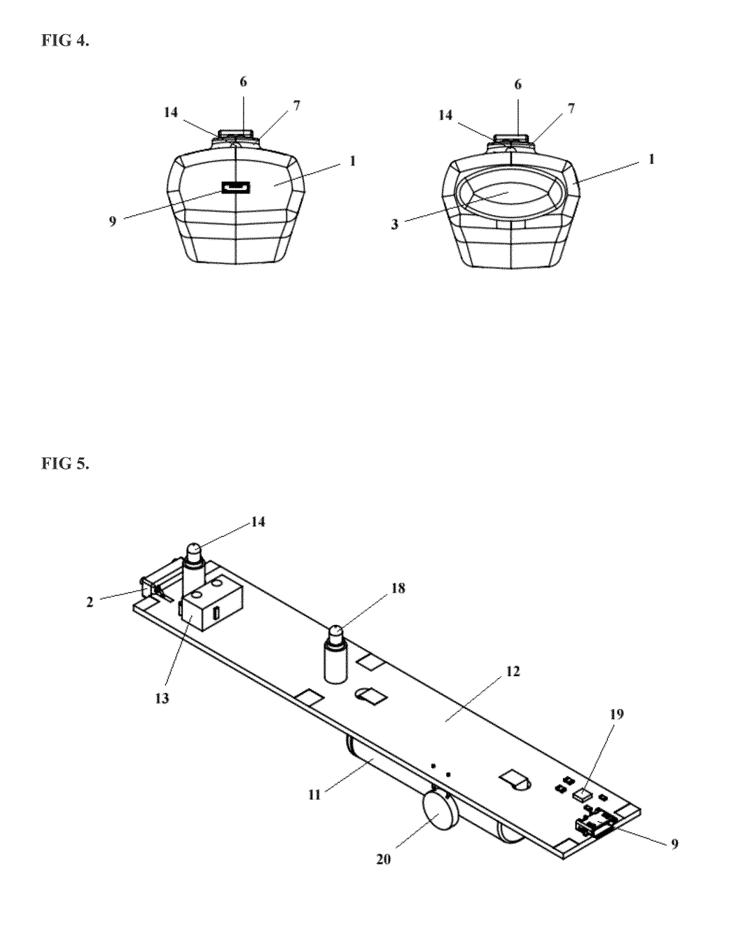

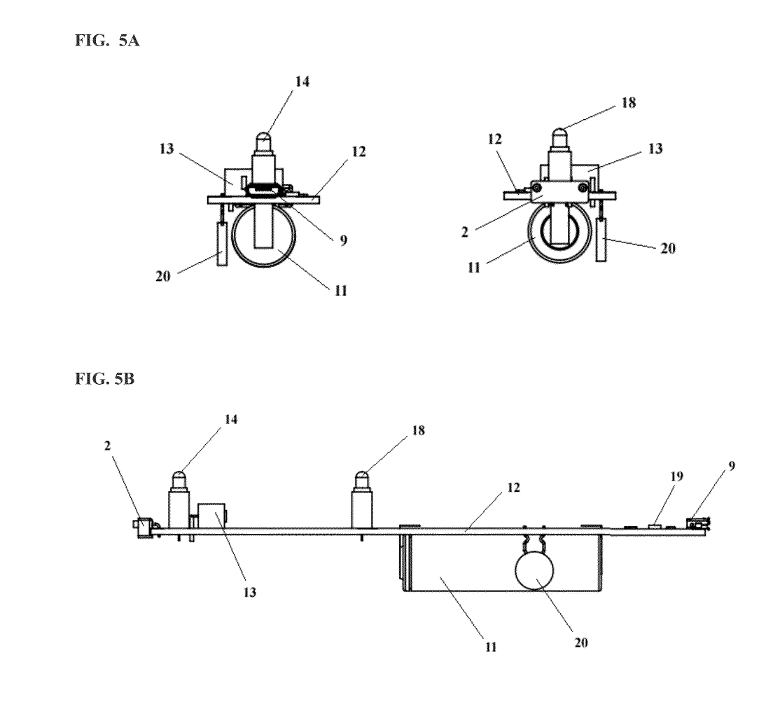

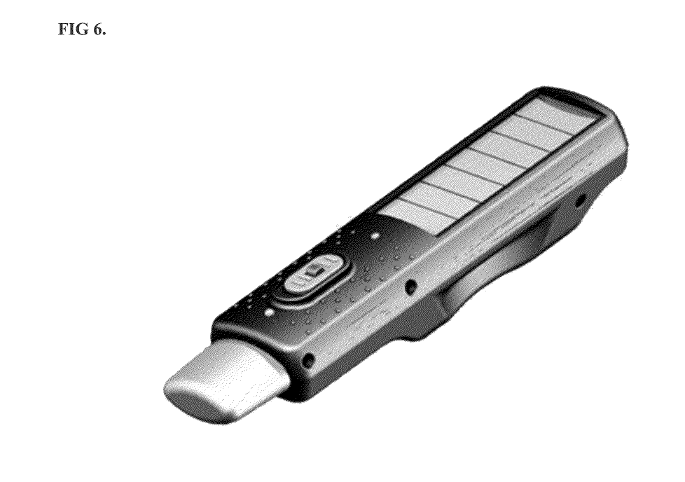

### DETAIL DESCRIPTION OF THE INVENTION

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

The present invention is directed toward a device for starting or igniting fire, such as camp fires for cooking and boiling water in an emergency response, disaster recovery situation, or disaster preparedness where butane, electric, or other ignition sources are not available. In the preferred embodiment of the present invention relates to a portable, electronic, solar rechargeable fire starting device, which comprises a generally cylindrically shaped housing (1), a removable heating coil assembly (2) with a removable protective cap (3). The device further includes a main chassis (5) that comprises a front tip end that is sealed to the housing (1) and an end cap (8) that is sealed to the housing (1) with a recessed mini 5 pin USB port (9) for external charging with a charge regulating circuit (12) equipped with LED indicators (18) which illuminate while charging to denote charging or charged battery states. A top surface of the housing (1) includes a recessed 5V 70 Ma photovoltaic panel (4) for recharging a battery (11) within a battery housing (15). Preferably the battery (11) is an AA Lithium Iron Phosphate rechargeable battery.

The present invention may also include a slide switch (6) for powering the device which is equipped with a safety button (7) and micro switch (13) for sending electrical current from the battery (11) to the nichrome heating element (10). The switch (6) is arranged so that when the safety button (7) is depressed the switch (6) will slide forward to a second position to make contact with a microswitch (13) closing the circuit and sending the current. When the circuit is energized an activation LED (14) located near the front tip will illuminate. When released the switch (6) automatically retracts via an extension spring (17) and returns to an off/safe position.

The heat for lighting a fire is supplied by a nichrome wire heating element (10) attached to copper posts (16). The copper posts (16) are fixed to a heat resistant plastic base. The terminal pins are slid into a commercially available pin receptacle. The leads of the pin receptacles are connected to the microswitch (13) and activation LED (14).

The device is operated by simultaneously depressing the safety button (7) and sliding the switch (6) forward. The slide switch (6) is disabled from moving forward without depressing the safety button (7) while pushing the slide switch (6). When the slide switch (6) is released it is retracted via the extension spring (17), which is attached to the slide switch (6) and anchored to the chassis (5). The power is generated from a rechargeable Lithium Phosphate battery (11) located within a battery housing (15) inside the main device housing (1). The battery (11) may be trickle charged via solar energy by way of an on-board solar panel (4) encased on the top side of the device housing (1). Secondarily, the battery (11) can also be charged via an onboard mini USB circuit (12). The circuit (12) consists of a mini USB female connector (9) and several resisters, and a regulator (19). The regulator (19) allows quick charging via the external solar panel (4) and/or a USB connection to a computer. Based on which external device is used the regulator (19) senses when the battery (11) is fully charged. A resettable fuse (20) is provided for controlling energy output from the battery (11). The resettable fuse (20) prevents over discharging of the battery (11). The mini USB circuit board (12) is also equipped with LED indicators (18) for indication of battery charge status.

The instant invention has been shown and described in what it considers to be the most practical and preferred embodiments. It is recognized, however, that departures may be made there from within the scope of the invention and that obvious modifications will occur to a person skilled in the art.

What is claimed is:

1. A solar rechargeable, battery powered, electric igniting device comprising:
a cylindrical housing having a first and second end, a length, an top flat surface, and at least one heating element disposed at the first end;
a photovoltaic array disposed over the top surface, where the array is capable of receiving light;
at least one rechargeable battery;
a first indicator, where the first indicator indicates when the battery is receiving a charge or is fully charged;
a second indicator, where the second indicator indicates when the at least one heating element is being energized;
a slide mechanism to activate the device; and
a charge regulating circuit to regulate the charging of a battery and said a charge regulating circuit includes a means to connect to an external power source.

2. The electric igniting device according to claim 1, where said housing includes two protrusions 180° radially opposed from said inset flat surface.

3. The electric igniting device according to claim 1, further comprising a safety button to prevent unintended activation and said safety button.

4. The electric igniting device according to claim 1, where the at least one heating element is a releaseably engaged and replaceable.

5. The electric igniting device according to claim 1, where further includes a removable protective cap where the removable protective cap covers the at least one heating element.

6. The electric igniting device according to claim 1, the means to connect includes a recessed mini 5 pin USB port.

7. The electric igniting device according to claim 1, wherein the photovoltaic array includes a 5V 70 Ma photovoltaic panel.

8. The electric igniting device according to claim 1, where the battery is an AA lithium iron phosphate rechargeable battery.

9. The electric igniting device according to claim 1, where the slide mechanism sends electrical current from the battery to the at least one heating element.

10. The electric igniting device according to claim 1, where the second indicator includes an activation LED.

11. The electric igniting device according to claim 1, where the at least one heating element includes a nichrome wire heating element attached to copper posts and said copper posts are fixed to a heat resistant plastic base.

12. The electric igniting device according to claim 1, where the first indicator includes a LED indicator.

13. The electric igniting device according to claim 1, where the circuit includes a USB female connector, at least two resistors and a regulator, where the regulator allows for charging via the photovoltaic array and the USB female connector either independently or congruently.

14. The electric igniting device according to claim 13, where the circuit further includes a resettable fuse, where the resettable fuse prevents over discharging the battery.
